(19) United States
(12) Patent Application Publication
(10) Pub. No.: US 2008/0257737 A1
(43) Pub. Date: Oct. 23, 2008

(54) ELECTROPHORESIS METHOD, ELECTROPHORESIS MODULE AND ELECTROPHORESIS APPARATUS

(75) Inventor: Yukihisa WADA, Kyoto-shi (JP)

Correspondence Address: SUGHRUE MION, PLLC, 2100 PENNSYLVANIA AVENUE, N.W., SUITE 800, WASHINGTON, DC, 20037, US

(73) Assignee: SHIMADZU CORPORATION, Kyoto-shi (JP)

(21) Appl. No.: 11/864,287

(22) Filed: Sep. 28, 2007

(30) Foreign Application Priority Data
Apr. 18, 2007 (JP) 2007-109842

(51) Int. Cl. G01N 27/26

(52) U.S. Cl. 204/461; 204/606; 204/612

(57) ABSTRACT

Disclosed is a technique for electrophoresis analysis, capable of eliminating the need for labeling a sample with a fluorescent or radioactive material. An electrophoresis cell is formed with a plurality of electrophoretic paths arranged in parallel relation to each other. Each of the electrophoretic paths has an upper end serving as a sample injection end, and a lower end received in a sample receiver. Further, each of the electrophoretic paths has a plurality of microchannels each extending uniformly from a position apart from the upper end by a predetermined distance to the lower end. The microchannels serve as a diffraction grating for diffracting light which irradiates a surface of the electrophoresis cell in a direction perpendicular to the surface, to produce diffracted light.

### BACKGROUND OF THE INVENTION

1. Field of the Invention

The present invention relates to an electrophoresis method, an electrophoresis cell and an electrophoresis apparatus, used for various purposes, such as determination of DNA base sequence, and separation of proteins.

2. Description of the Related Art

In a process of determining a long base sequence of a DNA, such as human genome DNA, it is necessary for a DNA sequencer to have higher sensitivity and higher-speed/higher-capacity processing capabilities. As an apparatus meeting such a need, there has been known a multi-capillary DNA sequencer having a plurality of electrophoresis paths arranged in an array and each filled with a gel.

Through a treatment by the Sanger method, four types of DNA fragment samples are prepared which have end bases of A (adenine), G (guanine), T (thymine) and C (cytosine), respectively. Samples containing the four types of DNA fragments with the different end bases are injected into respective ones of the plurality of electrophoresis paths, such as a plurality of lanes of slab gels or a plurality of capillary columns each filled with a gel. These paths simultaneously electrophorese the sample mixture in the plurality of lanes or columns. In order to identify the four types of DNA fragments with the different end bases during detection in the electrophoretic process, there has been known a technique of labeling the DNA fragments with two or more types of fluorescent materials or radioactive materials [See, for example, JP 10-206385A.

The labeling using the fluorescent or radioactive materials for identifying the end bases A, Q C and T is required to set up a chemical treatment process for labeling. This leads to increase in cost.

### SUMMARY OF THE INVENTION

In view of the above circumstances, it is an object of the present invention to provide a technique for electrophoresis analysis, capable of eliminating the need for labeling a sample with a fluorescent or radioactive material.

In order to achieve the above object, according to a first aspect of the present invention, there is provided an electrophoresis method which comprises the steps of: providing an electrophoresis apparatus having an electrophoretic path formed with a diffraction grating which is made up of a plurality of uniform microchannels each having a channel width exhibiting a diffractive effect on light irradiating the microchannels, and disposed at least at a position away from a sample injection end of the electrophoretic path; preparing an unlabeled mixed sample including a plurality of sample components; filling the electrophoretic path with an electrophoretic medium; injecting the sample into the electrophoretic path from the sample injection end; applying an electrophoretic voltage between opposite ends of the electrophoretic path to separate the sample into the sample components while electrophoresing the sample; irradiating with light a specific portion of the diffraction grating located at a position away from the sample injection end of the electrophoretic path; and measuring diffracted light from the diffraction grating to detect that each of the electrophoretically separated sample components passes through the specific portion of the diffraction grating, based on a temporal change of the measured diffracted light.

Preferably, in the electrophoresis method of the present invention, the electrophoresis apparatus has at least four electrophoretic paths each formed with the diffraction grating at an aligned position equally distant from the respective sample injection ends of the electrophoretic paths. In this case, the step of preparing the sample may include dividing one nucleic acid as a sample, by types of end bases, to prepare four types of unlabeled nucleic-acid fragment samples, and the step of injecting the sample may include injecting the nucleic-acid fragment samples into the electrophoretic paths, individually. Further, the step of irradiating may include irradiating with light the respective diffraction gratings located at the aligned position of the electrophoretic paths, and the step of measuring may include detecting an order of the base types passing through the respective diffraction gratings to determine a base sequence of the nucleic acid.

According to a second aspect of the present invention, there is provided an electrophoresis module which is formed with an electrophoretic path having a sample injection end and adapted to electrophoretically separate a sample into its components by filling the electrophoretic path with an electrophoretic medium, injecting the sample from the sample injection end, and applying an electrophoretic voltage between opposite ends of the electrophoretic path to electrophorese the sample. The electrophoresis module comprises a diffraction grating which is made up of a plurality of uniform microchannels each having a channel width exhibiting a diffractive effect on light irradiating the microchannels, and formed in the electrophoretic path at least at a position away from the sample injection end of the electrophoretic path.

Preferably, the electrophoresis module of the present invention has a plurality of the electrophoretic paths. This makes it possible to simultaneously perform an electrophoresis analysis for plural types of samples.

In the above electrophoresis module, the diffraction grating may be formed only in a portion of the electrophoretic path to be irradiated with light. In this case, a length of the microchannels forming the diffraction grating can be reduced to suppress the occurrence of clogging of the microchannels.

According to a third aspect of the present invention, there is provided an electrophoresis apparatus which comprises: the electrophoresis module set forth in the second aspect of the present invention; an irradiation optical system for irradiating with light a specific portion of the diffraction grating located at a position away from the sample injection end of the electrophoretic path; an optical sensing device for sensing diffracted light from the diffraction grating irradiated with light from the light-emitting optical system; and a processing section for measuring a temporal change of the diffracted light, based on a sensing signal from the optical sensing device, to detect that each of the electrophoretically separated sample components passes through the specific portion of the diffraction grating.

In an exemplary embodiment, the electrophoresis apparatus of the present invention is formed as a base sequence determination apparatus for determining a base sequence of a nucleic acid, such as DNA. In this case, the electrophoresis module has at least four electrophoretic paths each formed with the diffraction grating. The irradiation optical system is operable to irradiate with light respective specific portions of the diffraction gratings located at an aligned position equally distant from the respective sample injection ends of the electrophoretic paths. Further, the processing section is operable, when one nucleic acid as a sample is divided by types of end bases to prepare four types of unlabeled nucleic-acid fragment samples, and the nucleic-acid fragment samples are supplied into the electrophoretic paths, individually, to detect an order of the four base types passing through the respective specific portion of the diffraction gratings irradiated with light from the irradiation optical system so as to determine a base sequence of the sample nucleic acid.

As above, the electrophoresis method and the electrophoresis apparatus of the present invention employs the electrophoresis module comprising a diffraction grating which is made up of a plurality of uniform microchannels each having a channel width exhibiting a diffractive effect on light irradiating the microchannels, and formed in an electrophoretic path at least at a position away from a sample injection end of the electrophoretic path. The electrophoresis method and the electrophoresis apparatus of the present invention are designed to irradiate with light a specific portion of the diffraction grating located at a position away from the sample injection end of the electrophoretic path, and measure diffracted light from the diffraction grating so as to detect that each of the electrophoretically separated sample components passes through the specific portion of the diffraction grating, based on a temporal change of the measured diffracted light. This makes it possible to eliminate the need for labeling a sample with a fluorescent or radioactive material and omit a process of labeling a sample so as to facilitate reduction in cost.

Other features and advantages of the present invention will be apparent from the accompanying drawings and from the detailed description.

### BRIEF DESCRIPTION OF THE DRAWINGS

FIG. 1 is a schematic block diagram showing an electrophoresis apparatus according to one embodiment of the present invention.

FIGS. 2A to 2D are explanatory diagrams of an electrophoresis cell in the electrophoresis apparatus, wherein: FIG. 2A is a front view of the electrophoresis cell; FIG. 2B is an enlarged view of the area indicated by the dashed circle in FIG. 2A; FIG. 2C is a sectional view taken along the line X-X in FIG. 2B; and FIG. 2D is a sectional view taken along the line Y-Y in FIG. 2A.

FIGS. 3A and 3B are explanatory diagrams of an electrophoresis method using the electrophoresis apparatus, according to one embodiment of the present invention, wherein FIG. 3A is a front view showing the electrophoresis cell just after injection of DNA fragments, and FIG. 3B is a front view showing a flow of samples in the electrophoresis cell during electrophoresis.

FIGS. 4A and 4B are graphs showing one example of an intensity distribution of diffracted light, wherein FIG. 4A shows the diffracted light intensity distribution when a sample has not reached a light irradiation position, and FIG. 4B shows the diffracted light intensity distribution when the sample reaches the light irradiation position.

FIG. 5 is a front view showing an electrophoresis cell according another embodiment of the present invention.

### DETAILED DESCRIPTION OF THE EMBODIMENTS

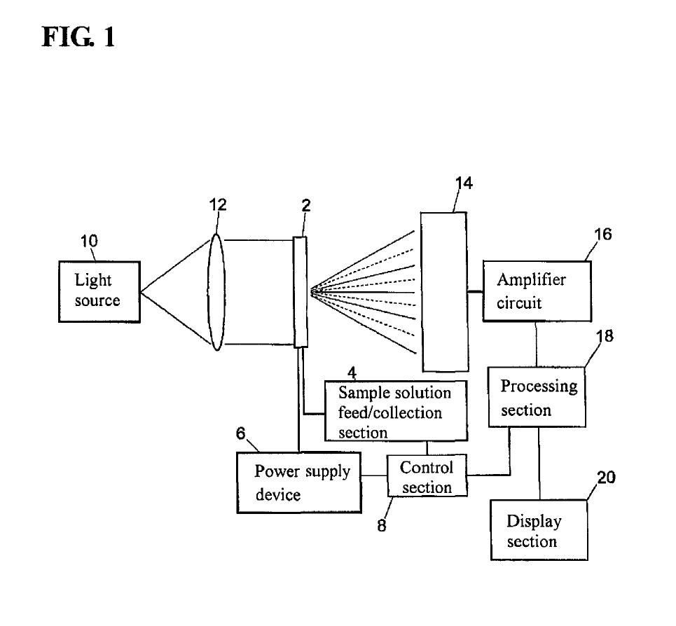

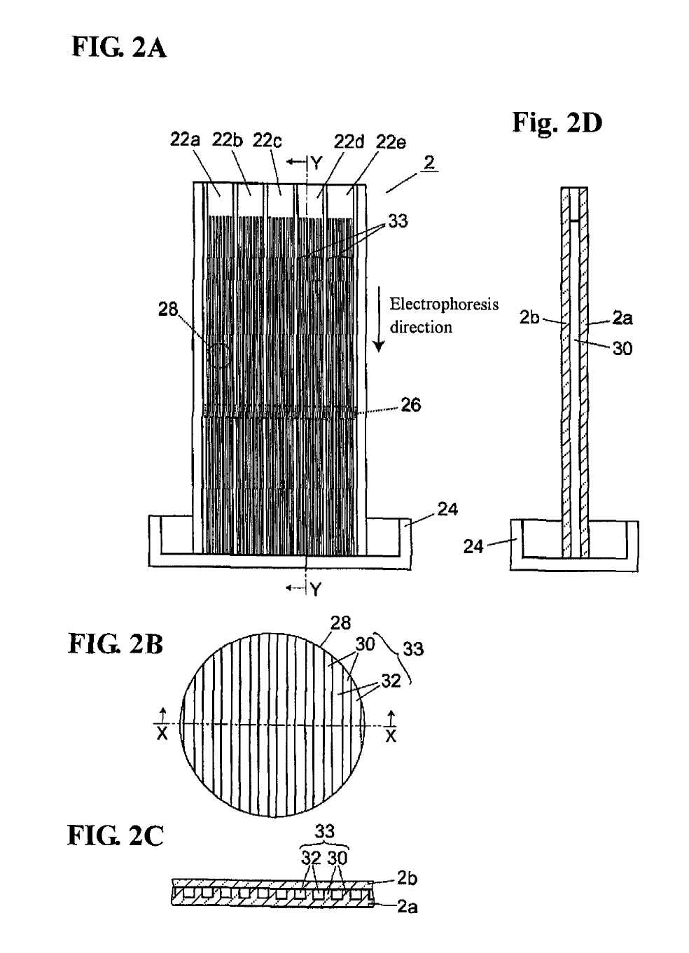

An electrophoresis apparatus, an electrophoresis method using the electrophoresis apparatus, and an electrophoresis cell for use in the electrophoresis apparatus will now be described based on exemplary embodiments of the present invention. FIG. 1 is a schematic block diagram showing an electrophoresis apparatus according to one embodiment of the present invention. FIGS. 2A to 2D are explanatory diagrams of an electrophoresis cell serving as an electrophoresis module in the electrophoresis apparatus, wherein: FIG. 2A is a front view of the electrophoresis cell; FIG. 2B is an enlarged view of the area indicated by the dashed circle 28 in FIG. 2A; FIG. 2C is a sectional view taken along the line X-X in FIG. 2B; and FIG. 2D is a sectional view taken along the line Y-Y in FIG. 2A.

First of all, the electrophoresis cell 2 will be described below.

As shown in FIGS. 2A to 2D, the electrophoresis cell 2 is formed with a plurality (in this embodiment, five) of electrophoretic paths 22a to 22e arranged in parallel relation to each other. Each of the electrophoretic paths 22a to 22e has an upper end serving as a sample injection end, and a lower end received in a sample receiver 24. Further, each of the electrophoretic paths 22a to 22e has a plurality of microchannels 33 each extending uniformly from a position apart from the upper end by a predetermined distance to the lower end.

Each of the electrophoretic paths 22a to 22e is filled with a gel serving as an electrophoretic medium, while leaving a small space only on the side of the upper end. A buffer solution is received in the upper end space above the gel in each of the electrophoretic paths 22a to 22e, and in the sample receiver below the lower end, to provide an electrical contact between respective ones of the upper and lower ends and electrodes during electrophoresis.

The electrophoresis cell 2 is formed by laminating two plate-shaped transparent substrates 2a, 2b each made, for example, of silica. Specifically, the transparent substrate 2b is a flat plate-shaped member. A surface of the transparent substrate 2a opposed to the transparent substrate 2b is formed with the five electrophoretic paths 22a to 22e, and a plurality of microchannels 33 in each of the electrophoretic paths 22a to 22e. FIGS. 2C shows a portion 28 of the microchannels 33. The microchannels 33 comprise regularly-arranged convexities 30 and concavities 32 which are formed by MEMS techniques. This structure is shown as one example. For example, the respective structures of the transparent substrates 2a, 2b may be reversed.

The microchannels 33 serve as a diffraction grating for diffracting light which irradiates a surface of the electrophoresis cell 2 in a direction perpendicular to the surface (in a direction perpendicular to the drawing sheet in FIG. 2A), to produce diffracted light. For example, the microchannels 33 are formed at a pitch of 10 to 100 μm. The region 26 surrounded by the dotted line in FIG. 2A is a light irradiation position to be irradiated with a light flux from an after-mentioned irradiation optical system comprising a light source 10 and a lens 12. The light irradiation position 26 is continuously irradiated with a light flux converged in a strip shape or scanningly irradiated with a light flux converged in a beam shape.

With reference to FIG. 1, an electrophoresis apparatus using the above electrophoresis cell 2 will be described.

The electrophoresis apparatus comprises a sample solution feed/collection section 4 for injecting a sample from the sample injection ends of the electrophoretic paths 22a to 22e of the electrophoresis cell 2, and a power supply device 6 for applying a voltage between the upper and lower ends of the electrophoretic paths 22a to 22e. Respective operations of the sample solution feed/collection section 4 and the power supply device 6 are controlled by a control section 8.

The electrophoresis apparatus includes a light source 10 and a lens 12 which serve as an irradiation optical system for irradiating the light irradiation position 26 of the electrophoresis cell 2 with light in a direction perpendicular to the electrophoresis direction. On the opposite side of the light source 10 and the lens 12 across the electrophoresis cell 2, the electrophoresis apparatus includes a light-receiving optical system 14 for measuring an intensity distribution of diffracted light produced by the microchannels 33 formed in the electrophoretic paths 22a to 22e of the electrophoresis cell 2. For example, the light-receiving optical system 14 is composed of an image sensor, such as a CCD (Charge Coupled Device) image sensor or a photodiode array. The light-receiving optical system 14 is electrically connected to a processing section 18 through an amplifier circuit 16. The electrophoresis apparatus further includes a display section 20 for displaying a processing result of the processing section 18 and other information.

FIG. 1 shows the electrophoresis apparatus when viewed downwardly from above the electrophoresis cell 2. That is, in this embodiment, the irradiation optical system is designed to irradiate the light irradiation position 26 of the electrophoresis cell 2 with light converged in a strip shape.

The processing section 18 is operable to read information about an intensity distribution of diffracted light, from the light-receiving optical system 14, so as to detect a change in the diffracted light intensity distribution. The diffracted light intensity distribution is changed when a sample in a specific one of the electrophoretic paths reaches the light irradiation position 26, and thereby a refractive index of the gel at the light irradiation position 26 in the specific electrophoretic path is changed. Thus, it can be determined which of the electrophoretic paths a sample component reaches the light irradiation position 26, by monitoring the diffracted light intensity distribution and detecting a change in the diffracted light intensity distribution. For this purpose, the processing section 18 is operable to monitor the diffracted light intensity distribution through the light-receiving optical system 14, and detect a specific one of the electrophoretic paths in which a sample component reaches the light irradiation position 26.

The processing section 18 may be provided with a storage circuit for storing an order of the electrophoretic paths each having a change in the diffracted light intensity distribution. An advantage of the storage circuit will be described in connection with the following description about an electrophoresis method.

An electrophoresis method using the above electrophoresis apparatus, according one embodiment of the present invention, will be described below.

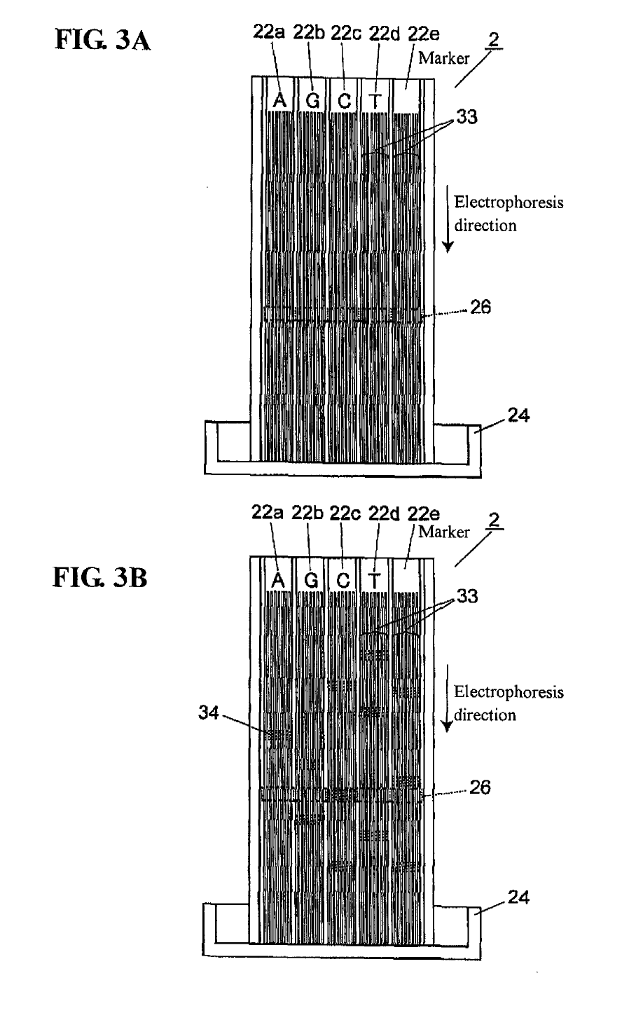

As shown in FIG. 3A, plural types of DNA fragments prepared, for example, by the Sanger method are injected into the respective electrophoretic paths 22a to 22e from the sample injection ends thereof. In this embodiment, a DNA fragment having an end base of A (adenine), a DNA fragment having an end base of G (guanine), a DNA fragment having an end base of T (thymine) and a DNA fragment having an end base of C (cytosine), are injected, respectively, into the electrophoretic path 22a, the electrophoretic path 22b, the electrophoretic path 22c and the electrophoretic path 22d, from the sample injection ends thereof. Further, a DNA fragment having a known base number and serving as a marker is injected into the electrophoretic path 22e from the sample injection end thereof. None of the DNA fragments to be injected into the respective electrophoretic paths 22a to 22e is labeled with a fluorescent material or a radioactive material.

Two electrodes electrically connected to the power supply device 6 are inserted in the buffer solution received in the upper end space of the electrophoresis cell 2 and the sample receiver 24 receiving therein the lower end of the electrophoresis cell 2, to apply a predetermined voltage between the upper and lower ends of the electrophoretic paths 22a to 22e. Thus, as shown in FIG. 3B, each of the samples in the sample injection ends is electrophoresed toward the sample receiver 24 through the gel in a corresponding one of the electrophoretic paths 22a to 22e, while allowing the sample to be separated into its components according to molecular masses thereof. In the samples which are being electrophoresed in the electrophoretic paths 22a to 22d, the DNA fragment with a smaller base number has a higher electrophoresis speed. Thus, the DNA fragments pass through the light irradiation position 26 in the order of base number from smallest to largest.

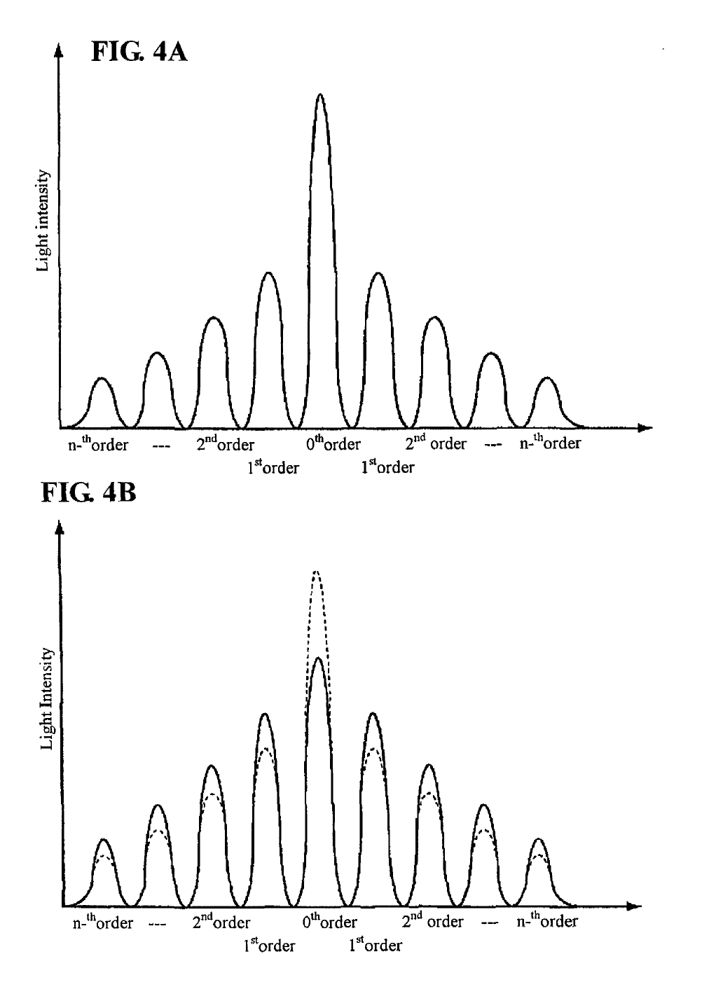

When one of the DNA fragments reaches the light irradiation position 26, a refractive index of the gel at the light irradiation position 26 is changed, and thereby a diffracted light intensity distribution detected by the light-receiving optical system 14 is changed as shown in FIG. 4B. FIGS. 4A and 4B are graphs showing one example of a diffracted light intensity distribution, wherein FIG. 4A shows the diffracted light intensity distribution when one of the samples has not passed through the light irradiation position 26, and FIG. 4B shows the diffracted light intensity distribution when the sample passes through the light irradiation position 26. A change in the diffracted light intensity distribution is read to detect that the sample component passes through the light irradiation position 26. In the electrophoresis apparatus illustrated in FIG. 1, the processing section 18 reads a change in the diffracted light intensity distribution to detect in which of the electrophoretic paths the DNA fragment reaches the light irradiation position 26.

When electrophoresis is simultaneously initiated in the electrophoretic paths 22a to 22e, the DNA fragments pass through the light irradiation position 26 in the order of molecular mass, i.e., base number, from smallest to largest. Thus, a base sequence of the DNA as a measurement target can be determined by measuring an order of changes of the diffracted light intensity distribution in the electrophoretic paths.

As mentioned above, the processing section 18 may be provided with a storage circuit for storing an order of the electrophoretic paths each having a change in the diffracted light intensity distribution during electrophoresis. This makes it possible to provide a base sequence determination apparatus capable of automatically determining a base sequence of a DNA.

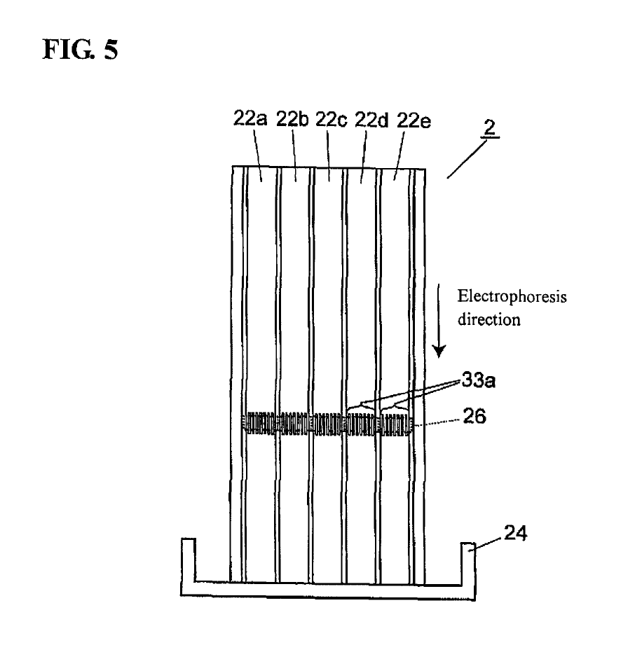

An advantageous embodiment of the invention has been shown and described. It is obvious to those skilled in the art that various changes and modifications may be made therein without departing from the spirit and scope thereof as set forth in appended claims. For example, while the plurality of uniform microchannels 33 in each of the electrophoretic paths 22a to 22e in the above embodiment extend from the position apart from the sample injection end by a small distance, to the lower end, the present invention is not limited to this structure. That is, as shown in FIG. 5, a diffraction grating 33a may be provided only in the light irradiation position 26. In this case, a length of the microchannels 33 can be reduced to suppress clogging of the microchannels 33 by a sample. Further, in FIG. 2A, a plurality of capillaries arranged in parallel relation to each other may be used in place of the microchannels 33.

What is claimed is:

1. An electrophoresis method, comprising:
providing an electrophoresis apparatus having an electrophoretic path formed with a diffraction grating which is made up of a plurality of uniform microchannels each having a channel width exhibiting a diffractive effect on light irradiating said microchannels, and disposed at least at a position away from a sample injection end of said electrophoretic path;
preparing an unlabeled mixed sample including a plurality of sample components;
filling said electrophoretic path with an electrophoretic medium;
injecting said sample into said electrophoretic path from said sample injection end;
applying an electrophoretic voltage between opposite ends of said electrophoretic path to separate said sample into said sample components while electrophoresing said sample;
irradiating with light a specific portion of said diffraction grating located at a position away from said sample injection end of said electrophoretic path; and
measuring diffracted light from said diffraction grating to detect that each of said electrophoretically separated sample components passes through said specific portion of said diffraction grating, based on a temporal change of said measured diffracted light.

2. The electrophoresis method as defined in claim 1, wherein said electrophoretic path comprises at least four electrophoretic paths, each formed with said diffraction grating at an aligned position equally distant from the respective sample injection ends of said electrophoretic paths, wherein:
said preparing the sample step includes dividing one nucleic acid as a sample, by types of end bases, to prepare four types of unlabeled nucleic-acid fragment samples;
said injecting the sample step includes injecting said nucleic-acid fragment samples into said electrophoretic paths, individually;
said irradiating includes irradiating with light the respective diffraction gratings located at said aligned position of said electrophoretic paths; and
said measuring includes detecting an order of said base types passing through the respective diffraction gratings to determine a base sequence of said nucleic acid.

3. An electrophoresis module, comprising:
an electrophoretic path having a sample injection end and adapted to electrophoretically separate a sample into its components by filling said electrophoretic path with an electrophoretic medium, injecting said sample from said sample injection end, and applying an electrophoretic voltage between opposite ends of said electrophoretic path to electrophorese said sample,
wherein said electrophoretic path includes a diffraction grating which is made up of a plurality of uniform microchannels each having a channel width exhibiting a diffractive effect on light irradiating said microchannels, said diffraction grating formed in said electrophoretic path at least at a position away from said sample injection end of said electrophoretic path.

4. The electrophoresis module as defined in claim 3, which has a plurality of said electrophoretic paths.

5. The electrophoresis module as defined in claim 3, wherein said diffraction grating is formed only in a portion of said electrophoretic path to be irradiated with light.

6. An electrophoresis apparatus, comprising:
the electrophoresis module as defined in claim 3;
an irradiation optical system for irradiating with light a specific portion of said diffraction grating located at a position away from said sample injection end of said electrophoretic path;
an optical sensing device for sensing diffracted light from said diffraction grating irradiated with light from said light-emitting optical system; and
a processing section for measuring a temporal change of said diffracted light, based on a sensing signal from said optical sensing device, to detect that each of said electrophoretically separated sample components passes through said specific portion of said diffraction grating.

7. The electrophoresis apparatus as defined in claim 6, wherein:
said electrophoretic path comprises at least four electrophoretic paths, each formed with said diffraction grating;
said irradiation optical system is operable to irradiate with light respective specific portions of said diffraction gratings located at an aligned position equally distant from the respective sample injection ends of said electrophoretic paths;
said processing section is operable, when one nucleic acid as a sample is divided by types of end bases to prepare four types of unlabeled nucleic-acid fragment samples, and said nucleic-acid fragment samples are supplied into said electrophoretic paths, individually, to detect an order of said four base types passing through the respective specific portion of said diffraction gratings irradiated with light from said irradiation optical system so as to determine a base sequence of said sample nucleic acid.

8. The electrophoresis module as defined in claim 4, wherein said diffraction grating is formed only in a portion of said electrophoretic path to be irradiated with light.

9. An electrophoresis apparatus, comprising:
the electrophoresis module as defined in claim 4;
an irradiation optical system for irradiating with light a specific portion of said diffraction grating located at a position away from said sample injection end of said electrophoretic path;
an optical sensing device for sensing diffracted light from said diffraction grating irradiated with light from said light-emitting optical system; and
a processing section for measuring a temporal change of said diffracted light, based on a sensing signal from said optical sensing device, to detect that each of said electrophoretically separated sample components passes through said specific portion of said diffraction grating.

10. An electrophoresis apparatus, comprising:
the electrophoresis module as defined in claim 5;
an irradiation optical system for irradiating with light a specific portion of said diffraction grating located at a position away from said sample injection end of said electrophoretic path;
an optical sensing device for sensing diffracted light from said diffraction grating irradiated with light from said light-emitting optical system; and
a processing section for measuring a temporal change of said diffracted light, based on a sensing signal from said optical sensing device, to detect that each of said electrophoretically separated sample components passes through said specific portion of said diffraction grating.

11. An electrophoresis apparatus, comprising:
the electrophoresis module as defined in any one of claim 8;
an irradiation optical system for irradiating with light a specific portion of said diffraction grating located at a position away from said sample injection end of said electrophoretic path;
an optical sensing device for sensing diffracted light from said diffraction grating irradiated with light from said light-emitting optical system; and
a processing section for measuring a temporal change of said diffracted light, based on a sensing signal from said optical sensing device, to detect that each of said electrophoretically separated sample components passes through said specific portion of said diffraction grating.

12. The electrophoresis apparatus as defined in claim 9, wherein:
said electrophoretic path comprises at least four electrophoretic paths, each formed with said diffraction grating;
said irradiation optical system is operable to irradiate with light respective specific portions of said diffraction gratings located at an aligned position equally distant from the respective sample injection ends of said electrophoretic paths;
said processing section is operable, when one nucleic acid as a sample is divided by types of end bases to prepare four types of unlabeled nucleic-acid fragment samples, and said nucleic-acid fragment samples are supplied into said electrophoretic paths, individually, to detect an order of said four base types passing through the respective specific portion of said diffraction gratings irradiated with light from said irradiation optical system so as to determine a base sequence of said sample nucleic acid.

13. The electrophoresis apparatus as defined in claim 10, wherein:
said electrophoretic path comprises at least four electrophoretic paths, each formed with said diffraction grating;
said irradiation optical system is operable to irradiate with light respective specific portions of said diffraction gratings located at an aligned position equally distant from the respective sample injection ends of said electrophoretic paths;
said processing section is operable, when one nucleic acid as a sample is divided by types of end bases to prepare four types of unlabeled nucleic-acid fragment samples, and said nucleic-acid fragment samples are supplied into said electrophoretic paths, individually, to detect an order of said four base types passing through the respective specific portion of said diffraction gratings irradiated with light from said irradiation optical system so as to determine a base sequence of said sample nucleic acid.

14. The electrophoresis apparatus as defined in claim 11, wherein:
said electrophoretic path comprises at least four electrophoretic paths, each formed with said diffraction grating;
said irradiation optical system is operable to irradiate with light respective specific portions of said diffraction gratings located at an aligned position equally distant from the respective sample injection ends of said electrophoretic paths;
said processing section is operable, when one nucleic acid as a sample is divided by types of end bases to prepare four types of unlabeled nucleic-acid fragment samples, and said nucleic-acid fragment samples are supplied into said electrophoretic paths, individually, to detect an order of said four base types passing through the respective specific portion of said diffraction gratings irradiated with light from said irradiation optical system so as to determine a base sequence of said sample nucleic acid.
